(19) United States
(12) Patent Application Publication
(10) Pub. No.: US 2001/0056447 A1
(43) Pub. Date: Dec. 27, 2001

(54) Information providing system and information providing method

(75) Inventor: Toru Sumino, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/887,077

(22) Filed: Jun. 25, 2001

(30) Foreign Application Priority Data
Jun. 26, 2000 (JP) 190432/2000

(51) Int. Cl. G06F 17/00

(52) U.S. Cl. 707/513; 707/517

(57) ABSTRACT

To provide system to easily and quickly integrate and display information required by a user in accordance with the user's setup.

The system includes a network; a terminal which is connected to the network and transmits page setup information, which includes addresses of web pages which a user intends to integrate into a single page and information which indicate a layout of the single page, to said network; and

a server which includes a registration element which registers the page setup information, a page generation element which generates the single page based on the page setup information, and a communication element which receives the page setup information from the network and transmits the single page to the terminal via the network.

### BACKGROUND OF THE INVENTION

The present invention relates to an information providing system via a communication network, for example, the Internet or the like, and more particularly, to an information providing system and an information providing service method for integrating and providing information, required by a user, from information collected via the communication network, in accordance with the user's setup.

In recent years, a web browsing is widely used, and users can easily obtain various information and services via a communication network.

For example, the user establishes connection of his/her personal computer with a communication network, and obtains information on the latest news, weather forecast, stock price, exchange rate, map, time table of trains, airplanes or the like, various statistical data, and the like. Further, the user can participate in bulletin-boards communication related to entertainment, hobby and the like, and can download software and search for these information.

However, the conventional information collecting via the communication network has problems as follows.

The information required by the users are often on different plural sites, therefore, conventionally, to browse the information on the different plural sites, it has been necessary to independently access the respective sites, and sequentially independently display the required information, thus requiring troublesome work and time.

Further, even in a case where information required by the user is only a part of a page, to display the information of this part, it has been necessary to display the entire page, thus wastefully consuming time and communication cost. Especially, in a case where a part of the page which is not required by the user has a large sized object such as an image or a moving picture, it has taken much time to display the page, and has been inconvenient.

Further, in a case where the user wants to simultaneously display respective different plural pages on the terminal, conventionally, it has been necessary to open plural web-browse-windows and designate the desired pages and display them in the plural browsers, thus requiring troublesome work and time.

In this manner, the conventional way of collecting information via the communication network is susceptible to improvement.

### SUMMARY OF THE INVENTION

An object of the present invention is to solve the drawbacks of the above-described conventional art and provide an information providing system and an information providing service method to easily and quickly integrate and display information required by a user in accordance with the user's setup.

An information-providing system according to the present invention includes The system includes a network; a terminal which is connected to the network and transmits page setup information, which includes addresses of web pages which a user intends to integrate into a single page and information which indicate a layout of the single page, to said network; and a server which includes a registration element which registers the page setup information, a page generation element which generates the single page based on the page setup information, and a communication element which receives the page setup information from the network and transmits the single page to the terminal via the network.

### BRIEF DESCRIPTION OF THE DRAWINGS

These and other objects, features and advantages of the invention will become more apparent from the following detailed description when taken in conjunction with the accompanying drawings, in which:

FIG. 1 is a block diagram showing the configuration of the information providing system according to an embodiment of the present invention;

FIG. 2 is a block diagram showing the construction of the server 10 according to the embodiment of the present invention;

FIG. 3 is a flowchart for explaining the processing of the information providing system 100 according to the embodiment of the present invention;

FIG. 4 is a diagram for explaining the information providing web page 400;

FIG. 5 is diagram for explaining the sample images of layout of the information providing web page;

FIG. 6 is a diagram for explaining the setup operation of page to be displayed according to the embodiment of the present invention;

FIG. 7 is a diagram showing the display example of the program tables of the respective TV stations according to the embodiment of the present invention; and

FIG. 8 is a diagram showing the display example of the page of results of search by the respective search sites according to the embodiment of the present invention.

### DESCRIPTION OF THE PREFERRED EMBODIMENT

A preferred embodiment of the present invention will be described in detail below with reference to the accompanying drawings.

Referring to FIG. 1, the information providing system 100 of an embodiment of present invention includes a server 10, a database 20, terminals 30, web sites 40 and a communication network 50.

The server 10 on the communication network 50 provides a user of the terminal 30 with information providing service described in the following.

The terminal 30 has a web browser. The terminal 30 accesses the server 10 via the communication network 50 to receive the information providing service. The terminal 30 is, for example, a personal computer, a notebook-type personal computer, a Personal Digital Assistant and the like.

In response to a request of the terminal 30, the server 10 transmits an information providing web page to the terminal 30. The information providing web page shows contents which the user intends to view, by a predetermined layout designated by the user or a manager of the server 10. The information providing web page is embedded information of location of the contents, for example, Uniform Resource Identifier (URL) of the contents. The contents are located on the web site 40.

The web site 40 located on a corresponding web server on the network 50 is conventional one. Therefore, contents of the web site 40, is for example, news, weather forecast, stock price information, entertainment information, chat, bulletin board and the like.

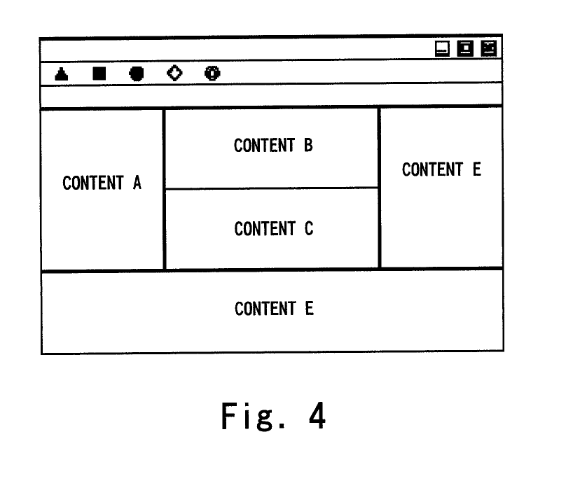

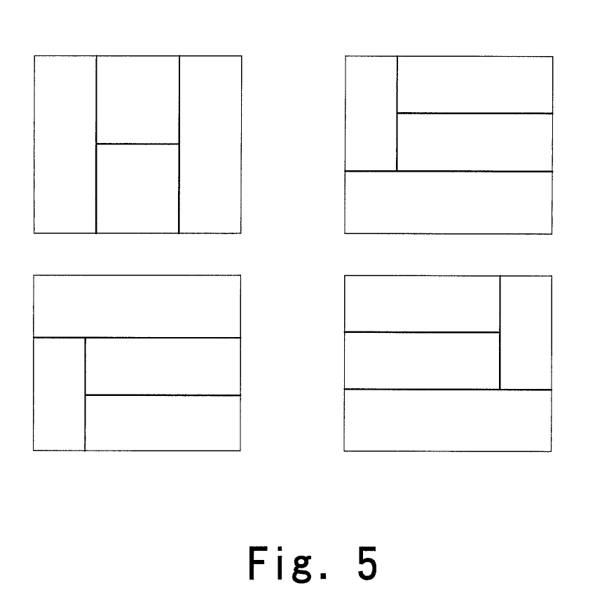

Referring to FIG. 4, an information providing web page 400 shows contents A, B, C, D and E, which are located on the web site 40 respectively. In the information providing web page 400, these contents are separated by frames. Namely, the web pages, which show these contents A, B, C, D, are integrated into a single page, the information providing web page 400. An entire web page or content(s) in one or plural frames in the web page in the site 40 may be available as the content(s) showed in the information providing web page 400.

The data base 20 is connected to the server 10. The database 20 stores information of the layout of the web page sent to the terminal 30 as, for example, HTML codes. In the example as shown in FIG. 4, the database 20 stores information of locations of the contents A, B, C, D and E (for example, URL) and information of a layout of the information providing web page 400. Hereinafter, these informations are referred to as page setup information.

The database 20 also stores sample images of layout of the information providing web page. The sample images corresponding to each number of contents to be separated by frames are stored in the database 20. Therefore, in case that the number of contents is 4, examples of sample images are as shown in FIG.

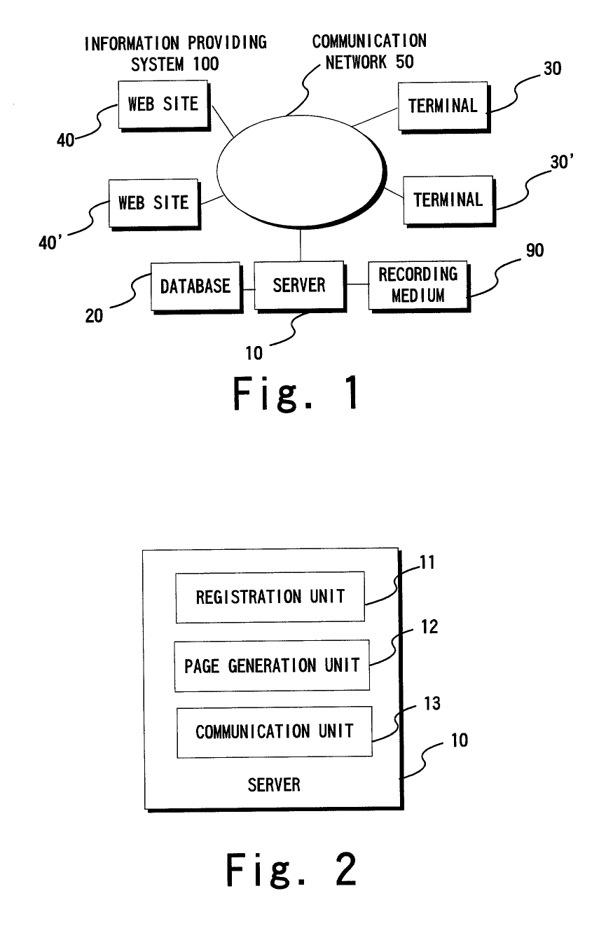

Next, the server 10 will be described in detail below. Referring to FIG. 2, the server 10 includes a registration unit 11, a page generation unit 12 and a communication unit 13.

The registration unit 11 registers the page-setup information in the database 20 for each user. The page-setup information is input from the terminal 30 by communication between the terminal 30 and the server 10 or input by an operation of the manager of server 10 as described later.

The page generation unit 12 generates the information providing web page to be transmitted to the terminal 30 in accordance with the page setup information registered in the database 20. The page generation unit 12 generates HTML text code of the information providing web page.

The communication unit 13 is interface of communicating with the terminal 30 and transmits the information providing web page to the terminal 30 in response to the request of the terminal 30 via the communication network 50.

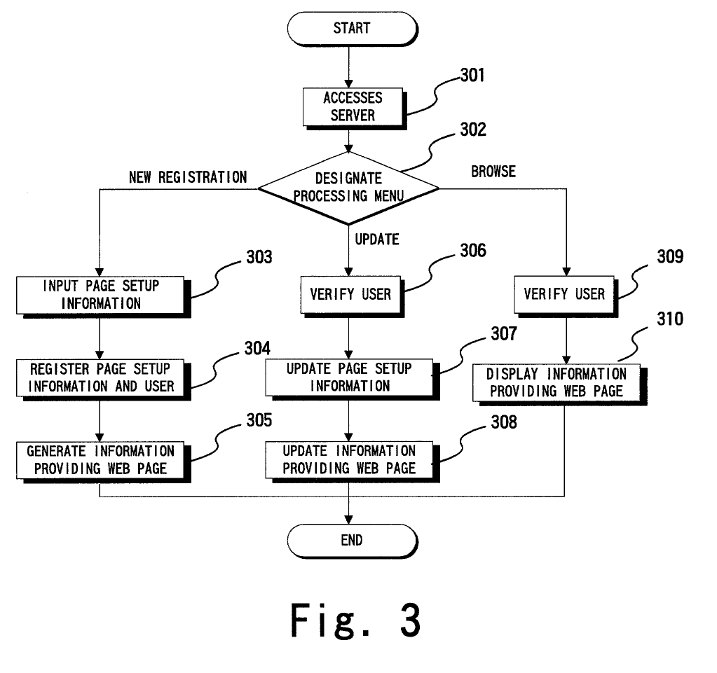

Referring to FIG. 3, the user accesses a predetermined web page on the server 10 from the terminal 30 (step 301), and designates a processing menu to be executed, which is showed on the web page (step 302). The web page allows the user to perform new registration of the page setup information, updating the information and the like.

Then, in case that new registration of the page setup information is designated by the user, registration processing described as follows are performed.

The user inputs the number of web pages to want to view in the information providing web page to the terminal 30. Then, the terminal 30 transmits the number to the server 10 and the number is received by the communication unit 13. The registration unit 11 selects the sample images corresponding to the number in the database 20 and the communication unit 13 transmits the images to the terminal 30.

The user chooses a preferred one from the images, and the terminal 30 transmits information indicating the selected image to the server 10. The terminal 30 also transmits information indicating which web pages arranged in which place on the information providing web page corresponding to the selected image (step 303).

These information are received by the communication unit 13. The registration unit 11 relates these information to an ID of the user and registers these information into the database 20 as the page setup information(step 304).

Then, the page generation unit 12 generates an information providing web page in accordance with the page setup information (step 305). Therefore, the page generation unit 12 generates code of HTML text or the like of the information providing web page.

Then, the communication unit 13 transmits the information providing web page generated by the page generation unit 12 to the terminal 30 in accordance with the terminal 30's request. The web page is browsed by the browser of the terminal 30.

Further, the number of pages the respective users can set is not limited to one but plural types of pages maybe set. Further, for example, a web page for an at-a-glance display of the set pages by each classification may be provided.

Further, processing of update, addition, deletion and the like can be performed on the pages registered by the respective users in a similar manner to the processing of new registration.

First, when the user opens a predetermined page for adding a page, the server 10 performs verification of the user to perform the operation (step 306). The verification of the user can be made by the user's inputting a user ID and a password or by registering Cookie, which is used for web server for identification and management of users, into the user's browser upon e.g. new registration (step 304), and checking it.

The registration unit 11 updates (or deletes) the page setup information registered in the database 20 by designation from the terminal 30 (steps 307), and the page generation unit 12 generates the updated information providing web page (step 308).

Further, in a case where the user browses the information providing web page, first, the server 10 verifies the user as in the case of step 306 (step 309). Then, the information providing web page is displayed in the web browser of the terminal 30 (step 310).

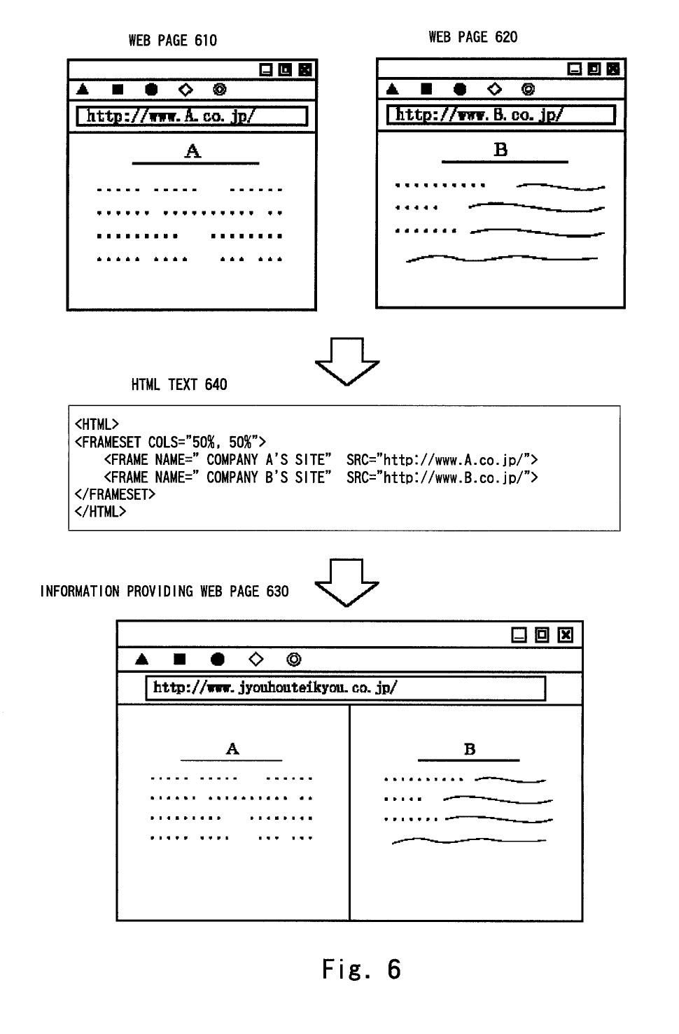

Referring to FIG. 6, when the user wants to view both a web page 610 which is Company A's site on the web site 40 and a web page 620 which is Company B's site on the web site 40′ as a single-window web page, the page setup information transmitted to the server 10 includes URLs of the web pages 610 and 620 and information indicating layout of the information providing web page 630. The Company B's site may be on the web site 40. In this example, the page generation unit 12 generates HTML text 640.

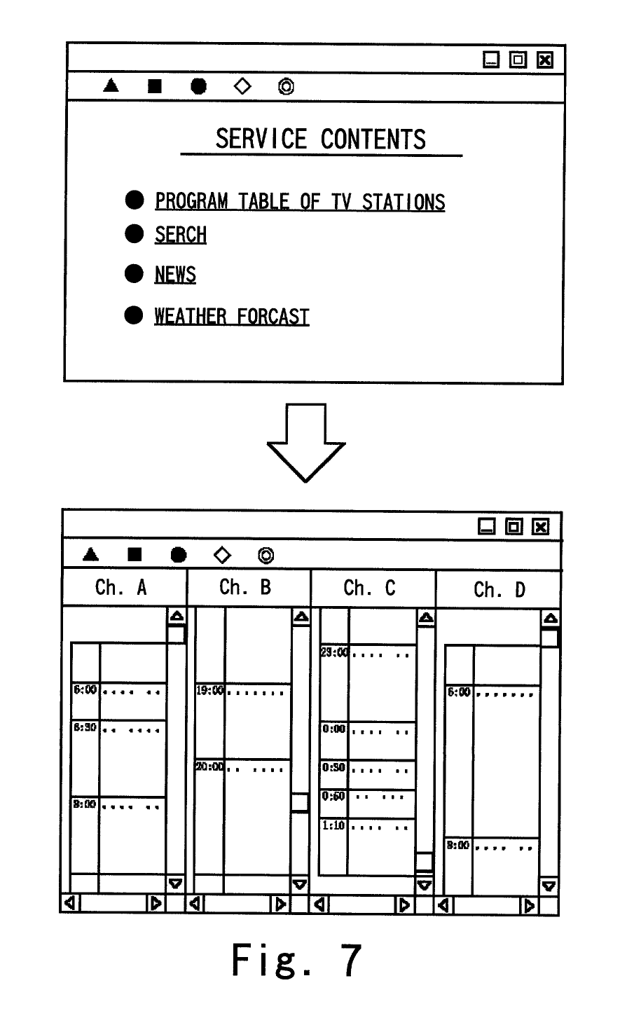

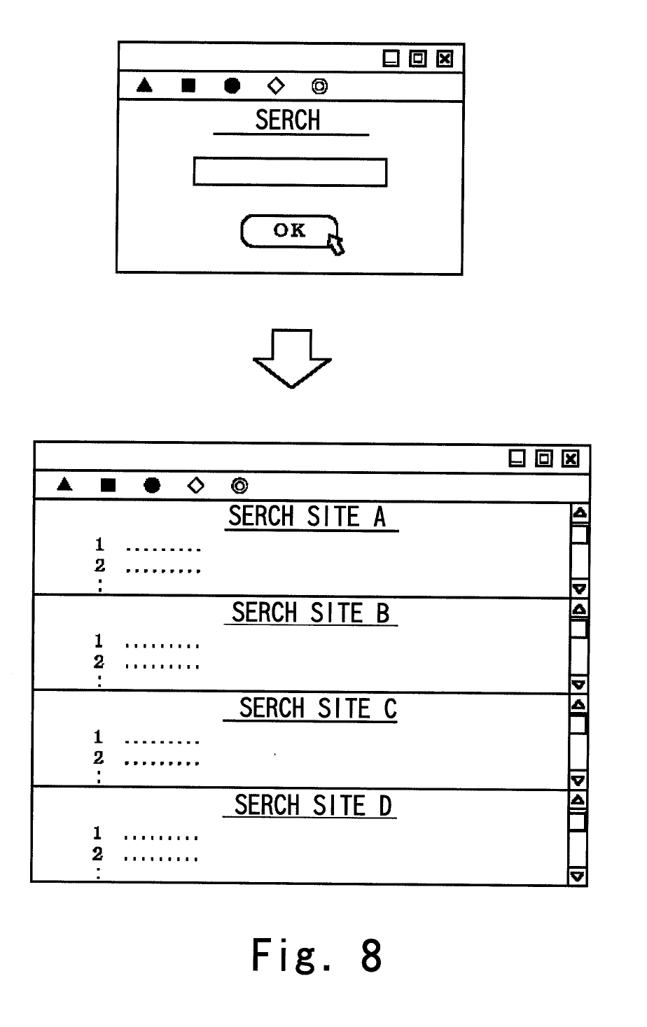

FIGS. 7 and 8 show examples of the information providing web page.

Referring to FIG. 7, when the terminal 30 logins the server 10, an at-a-glance page, which shows a list of predetermined service contents, is displayed, and a page to be displayed is selected by the user from the list. When the user clicks “PROGRAM TABLE OF TV STATION”, a information providing web page to display web pages of program tables of TV stations, which were designated and registered by the user, is and displayed.

Referring to FIG. 8, the results of search by plural search sites are simultaneously displayed by utilizing the service of search site to search for pages corresponding to an input keyword. In this example, a keyword for a search is inputted in a search page of an information providing site and transmitted, then the keyword is transmitted to the respective search sites. The results of search returned from the respective search sites are displayed end to end by using frames.

Further, a company who manages the information providing system 100 can obtain the management cost from advertisement rates by displaying banner advertisements on respective web pages in the information providing web site. Further, in case of provider who provides an internet access service or telephone company who provides telephonic communication services, free information providing services may be provided to users of the company.

Further, in the display example of FIG. 4 and the like, the contents displayed on information providing web page link to the web page on the web site 40, however, it may be arranged such that all the contents are collected in advance and recorded in the database 20 periodically. In this case, when the user refers to the information, as it is not necessary to collect information simultaneously from the many web sites 40, the information can be quickly browsed.

Further, the contents of the information providing web page may be arbitrarily extracted, processed by the page generation unit 12 or the like.

That is, in many web sites 40, as an article is often described in a web page in accordance with a predetermined format, only the article can be extracted and provided by analyzing the web page construct. Further, it is conceivable to perform processing to delete description in the original web page to execute CGI and various script commands or to correct these scripts and the like to code appropriate to publication from the server 10, or to correct description of linkage destination to an image, another web page and the like to a linkage destination appropriate to publication from the server 10 or to delete the description.

Further, as news and the like in the various web sites 40, not only the latest information are publicized at a predetermined address. In some web sites, an address to publicize the latest information is updated whenever necessary. For example, there is a web site which uses data indicative of date or time as a file name of a web page to publicize news or the like. To refer to the latest information publicized by such information providing site 40, it has been necessary to directly access the web site 40 and display the information through the link from its home page or index page or the like. The page generation unit 12 or the like may updates the address of page required by the user and generates a information providing web page appropriately, thereby such problem can be resolved. The latest address of the page required by the user may be generated in accordance with a predetermined algorithm (by designating a web page indicative of date or the like as a file name), or by referring to the address of linkage destination from an index page of the web site 40.

By the information providing system 100 of the present invention as described above, the latest information publicized by the plural web sites 40 can be integrated in one page and displayed by a layout set by the user.

Note that in the information providing system 100, the registration unit 11, the page generation unit 12 and the communication unit 13 in the server 10 and the other functions can be realized as hardware, but can be realized by loading a computer program having the respective functions to a memory of computer processing device. The computer program is stored into a recording medium 90 of a magnetic disk, a semiconductor memory or another medium. Then, the program is loaded from the recording medium to the computer processing device, and realizes the above-described respective functions by controlling the operation of the computer processing device.

As described above, according tot he information providing system of the present invention, the effects as follows can be attained.

First, by the information providing system of the present invention, information required by a user can be easily and quickly collected and provided with efficiency.

Secondly, by the information providing system of the present invention, information of plural web sites which the user wants to browse, can be integrated in accordance with the user's setup and simultaneously browsed, in one display, without independently accessing the respective sites.

Thirdly, the wasteful and troublesome work and time accompanying the conventional information search via a communication line for the Internet or the like can be reduced, and all the information required by the user can be instantaneously displayed.

While this invention has been described in conjunction with the preferred embodiment described above, it will now be possible for those skilled in the art to put this invention into practice in various other manners.

What is claimed is:

1. An information-providing server comprising:
a communication element which receives page setup information, which includes addresses of web pages which a user intends to integrate into a single page and information which indicate a layout of said single page, from a terminal via a network, and transmits said web page to said terminal via said network.
a registration element, which registers said page setup information; and
a page generation element, which generates said single page based on said page setup information.

2. An information-providing server according to claim 1, wherein said communication element receives the number of said web page from said terminal, transmits layout images to said terminal based on the number, and receives information indicating the layout image selected by said terminal as a layout of said single page.

3. An information-providing system comprising:
a network;
a terminal which is connected to said network and transmits page setup information, which includes addresses of web pages which a user intends to integrate into a single page and information which indicate a layout of said single page, to said network; and
a server which includes a registration element which registers said page setup information, a page generation element which generates said single page based on said page setup information, and a communication element which receives said page setup information from said network and transmits said single page to said terminal via said network.

4. An information-providing system according to claim 3, wherein said communication element receives the number of said web page from said terminal, transmits layout images to said terminal based on the number, and receives information indicating the layout image selected by said terminal as a layout of said single page.

5. An information-providing method comprising the steps of:
transmitting page setup information, which includes addresses of web pages which a user intends to integrate into a single page and information which indicate a layout of said single page to a server from a terminal via a network;
generating said single page based on said page setup information by said server; and
sending said single page from said server to said terminal via said network.

6. An information-providing method according to claim 5, comprising further steps of:
transmitting the number of said web page to said server from said terminal;
transmitting layout images to said terminal based on the number to said terminal from said sever; and
transmitting information indicating the layout image selected by said terminal as a layout of said single page to said server from said terminal.
